(19) United States
(12) Patent Application Publication
(10) Pub. No.: US 2004/0076735 A1
(43) Pub. Date: Apr. 22, 2004

(54) Method for making kosher pet food

(76) Inventors: Martine Lacombe, Fort Lauderdale, FL (US); Marc Michels, Fort Lauderdale, FL (US)

Correspondence Address: Martine Lacombe, Suite 567, 6278 N. Federal Hwy., Fort Lauderdale, FL, 33308, US

(21) Appl. No.: 10/273,463

(22) Filed: Oct. 18, 2002

(51) Int. Cl. A23L 1/31

(52) U.S. Cl. 426/641

(57) ABSTRACT

A pet food composition is provided for domesticated cats and dogs which contains from about 5 to 60 weight percent of kosher-species animal protein. This composition further includes a source of carbohydrates derived from grains EXCLUDING wheat, barley, rye, oats, spelt, or their derivatives, a source of fiber derived from vegetables and a source of fat derived from kosher-species animal fat. This composition and the utensils used in its preparation have no contact with dairy products. The pet food composition is fed to domesticated cats and dogs for which a kosher diet is recommended for health and/or spiritual reasons.

### CROSS-REFERENCE TO RELATED APPLICATIONS

Not applicable.

### BACKGROUND

1. Field of Invention

This invention relates to pet food, specifically domesticated cats and dogs for which a kosher diet is recommended for health and/or spiritual reasons.

2. Description of Prior Art

Dog and cat foods are generally formulated from a combination of proteinaceous and farinaceous materials. The proteinaceous material is derived from either vegetable protein sources or from meat and/or meat by-product sources, and nutritional supplements are often added. The farinaceous material is derived from grain products and contains starch as a major component.

Generally, commercially available pet food is composed of the leftovers of the agriculture industry. Pet food provides a place for slaughterhouse waste and grains considered unfit for human consumption to be turned into profit. This waste includes esophagi and possibly diseased and cancerous meat. The grains used have had the starch removed and the oil extracted—usually by chemical processing—for vegetable oil, or they are the hulls and other remnants from the milling process. Some of the truly whole grains used may have been deemed unfit for human consumption because of mold, contaminants, or poor storage practices.

The flesh of animals who fall into one of the categories of the four D's—dead, dying, diseased, or disabled—is what often goes into pet food. Many of these animals have died of infections, dehydration, or exposure to extreme heat or cold. In all but a few states, it is legal to remove unusable parts from chickens and sell them to pet food manufacturers. For example, some cheap or generic kibble-type dog food contains ground-up feathers. In the chicken inspection lines, deformed or tumorous legs are often cut off and put in a separate area for nonhuman consumption. Another source of meat not mentioned on conventional pet food labels are dogs and cats. In 1990 the San Francisco Chronicle reported that euthanized companion animals were being used in pet food. Although pet food manufacturers vehemently denied the report, the American Veterinary Medical Association confirmed the Chronicle's story.

Some veterinarians claim that feeding slaughterhouse wastes to animals increases their risk of getting cancer and other degenerative diseases. Commercially manufactured or rendered meat meals are highly contaminated with bacteria because their source is not always slaughtered animals. Animals that have died because of disease, injury, or natural causes are a source of meat for meat meal. The dead animal may not be rendered or cooked until days after its death. Therefore the carcass is often contaminated with bacteria—Salmonella bacteria contaminate 25-50% of meat meals. While the cooking process may kill bacteria, it does not eliminate the endotoxins that result from the bacteria. These toxins can cause disease.

While the AAFCO (American Association of Feed Control) established guidelines pertaining to the nutritional composition of pet food, it does not establish guidelines pertaining to the handling of the ingredients.

Several types of pet foods have been proposed—for example, in U.S. Pat. No. 5,695,797 (1997) and U.S. Pat. No. 5,968,569 (1999) to Nestec S. A.; U.S. Pat. No. 4,055,681 (1977), U.S. Pat. No. 4,228,195 (1980) U.S. Pat. No. 4,524,081 (1985) and U.S. Pat. No. 4,895,731 (1990) to The Quaker Oats Company; U.S. Pat. No. 4,190,679 (1980), U.S. Pat. No. 4,495,208 (1985) to General Foods Corporation; U.S. Pat. No. 4,310,558 (1982) to Ralston Purina Company; U.S. Pat. No. 4,784,860 (1988) to Novo Industri A/S; U.S. Pat. No. 4,910,038 (1990) and U.S. Pat. No. 5,045,339 (1991) to Huntington Hyde Ltd., Ind.; U.S. Pat. No. 5,294,458 (1994) to Maruha Corporation; U.S. Pat. No. 5,431,927 (1995); U.S. Pat. No. 5,500,239 (1996) and U.S. Pat. No. 5,690,988 (1997) to Colgate Palmolive Company; U.S. Pat. No. 5,616,569 (1997) and U.S. Pat. No. 5,851,573 (1998) to The Iams Company; U.S. Pat. No. 5,894,029 (1999) to Purebreed Pet Product, Inc.

Although these patents claim higher nutrition or improved palatability of their pet food products, none mentions the handling of ingredients as part of their manufacturing process.

All the pet foods heretofore known suffer from a number of disadvantages:

a) Their manufacture focuses on the palatability of the product with no regards to the nutritional content.

b) Products with high nutritional contents offer low palatability, leading to the pet eating less, therefore not getting the nutrients that the food product intends to deliver.

c) Products designed to alleviate a specific ailment in the pet, with no regards to the overall health of the animal or the product's palatability.

### SUMMARY

In accordance with the present invention a highly palatable pet food formulated from a combination of proteinaceous ingredients derived from kosher-species animal protein and farinaceous ingredients derived from grains EXCLUDING wheat, barley, rye, oats, spelt or their derivatives. Furthermore, during the manufacturing process, neither the food, nor the utensils used, come in contact with dairy products.

Objects and Advantages

Accordingly, several objects and advantages of the present inventions are:

a) to provide a highly palatable pet food.

b) to provide a pet food which is highly nutritional for pets regardless of their ages, ailments, or levels of activity.

c) To provide a pet food that does not promote discomfort or health hazards: dogs and cats should not consume dairy products. Neither cats nor dogs have the enzyme—lactase—that is needed to breakdown lactose. The overabundant lactose holds water in the small intestine, later producing diarrhea and/or vomiting. Because both diarrhea and vomiting strip liquids from the animal's system, this can be an uncomfortable and even dangerous condition.

d) To provide a pet food that can be used by people who wish to keep a kosher home during the Passover Holiday (free of Chametz): many pet owners need to get rid of their usual pet food during Passover because said food contains Chametz (leavened grains). These pet owners must resort to cooking their own pet food, which is impractical for many, not to mention detrimental to the pet's health as many of these owners do not possess the knowledge to cook a nutritionally adequate pet food.

e) To provide a pet food that can be endorsed by a Kosher agency: many people who keep a kosher home rely on the endorsement of a reputable Kosher Certification Agency to ensure quality and conformity of the food they use.

Further objects and advantages are to provide a pet food which can be served daily, with noticeable improvements to the animal's health, yet can easily be mass manufactured at a reasonable cost. Additionally, the product will be instantly embraced by people of Jewish faith who wish to keep a kosher home. Still further objects and advantages will become apparent from a consideration of the ensuing description and drawings.

### DRAWING FIGURES

FIG. 1 shows the composition of the pet food, which can be produced either moist for canned purposed or can be dehydrated.

FIG. 2 shows the high animal protein content of the present invention. Indeed, dogs and cats are meat eaters. Research has proven that a strictly vegetarian diet, or even a diet too low in animal protein, can cause diseases in cats and dogs. An often-fatal heart disease in cats and some dogs was shown to be caused by a deficiency of an amino acid only found in animal protein called taurine. Blindness is another symptom of taurine deficiency.

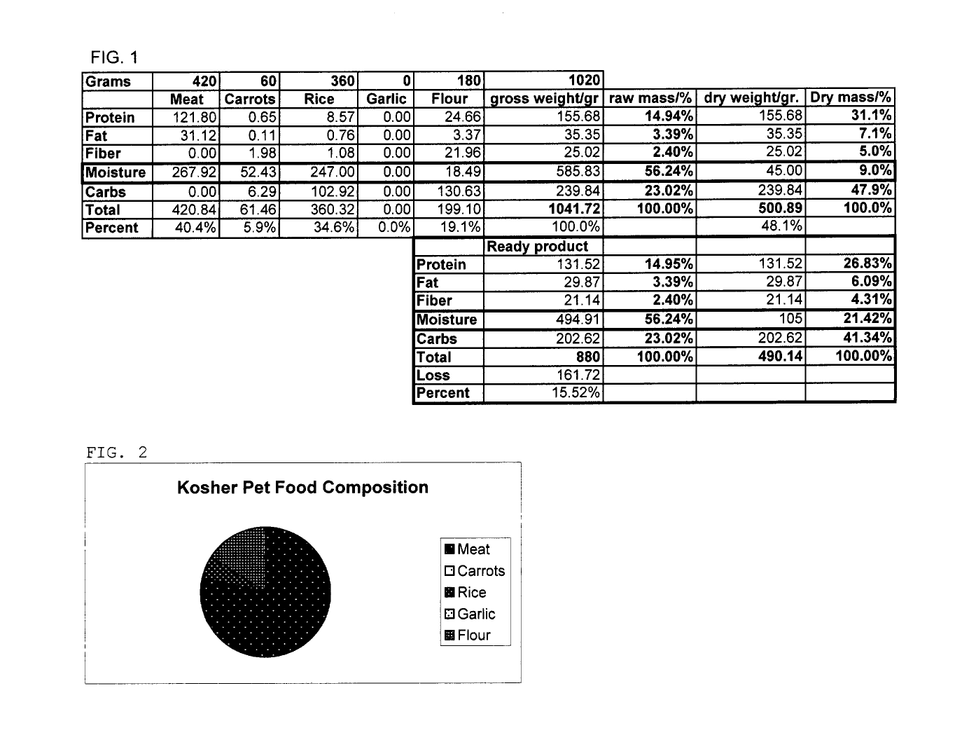

### DETAILED DESCRIPTION OF THE PREFERRED EMBODIMENTS

The pet food composition of the present invention may be provided in any suitable form as long as its protein source derives form kosher-species animal protein and it does not contain wheat, barley, rye, oats, spelt, or their derivatives, or dairy products, in the nutrient profiles mandated by the AAFCO.

It has been discovered that pet foods with a complete protein source has a high digestibility factor which promotes a pet's health by allocating its digestive resources to the acquisition of required nutrients instead of elimination of fillers. Digestibility refers to the quantity of the food that is actually absorbed by the pet's system. By providing a kosher-species animal protein source to the pet's diet (complete proteins: minimum 18% dry mass for adult/maintenance and 22% dry mass for growth foods) the amount of feces is reduced by 12-18%. The pet food composition of the present invention preferably comprises only about 40% dry mass carbohydrates in the form of grains EXCLUDING wheat, barley, rye, oats, spelt, or their derivatives, which maintains an appropriate ratio of energy to protein in the diet.

Suitable sources of fat include poultry, chicken, and turkey fat.

The pet food composition preferably further includes at least 2.5% omega-6 fatty acids and at least 0.25% omega-3 fatty acids.

The composition preferably includes about 5% by weight fiber. Suitable sources of fiber include vegetables, dried or whole, fruits, dried or whole, whole grains EXCLUDING wheat, barley, rye, oats, spelt, or their derivatives, and mixtures thereof.

The composition may also contain mixtures of vitamins and minerals including, but not limited to, zinc oxide, vitamin E, ascorbic acid, copper sulfate, manganese sulfate, biotin, manganous oxide, vitamin A acetate, calcium pantothenate, thiamine mononitrite, Vitamin B.sub.12 supplement, niacin, riboflavin supplement, inositol, Vitamin B.sub.6, potassium iodide, Vitamin D.sub.3 supplement, folic acid, sodium selenite, and cobalt carbonate.

### CONCLUSION, RAMIFICATION, AND SCOPE

Accordingly, the reader will see that the present invention offers advantages to pets, their owners, and pet food manufacturers.

a) The pet food is highly palatable with a high digestibility factor, promoting the pet's health (more nutrients absorbed with less efforts eliminating).

b) The pet owner deals with a lesser amount of waste (feces) and enjoys the companionship of a healthier pet.

c) Pet owners can share their philosophical believes with their pets.

d) Pet food manufacturers will find an immediate market amongst Jewish pet owners and other pet owners concerned with their pet's health.

Although the pet food of the present invention has been described with specificity by examples with specific components and specific ranges of components, it will be apparent to those of ordinary skill in the art that many modifications or substitutions with comparable components may be made to the pet food and the method for making the food which are suggested by the present invention and considered to be within the scope of the present invention.

What is claimed is:

1. A pet food composition comprising from about 5 to 60 weight percent of kosher-species animal protein, said composition further comprises a source of carbohydrates, a source of fiber, a source of fat, and at least 2.50% omega-6 fatty acids and 0.25% omega-3 fatty acids.

2. A pet food in accordance with claim 1 wherein said carbohydrate source consists essentially of grains EXCLUDING wheat, barley, rye, oats, spelt, or their derivatives, said fiber source consists essentially of vegetables and said fat source consists essentially of a kosher-species animal fat source.

3. A pet food in accordance with claims 1 or 2 where all animal protein ingredients used derive from a kosher species and neither the food, nor the utensils used, come in contact with dairy products throughout the preparation process.
